(19) United States
(12) Patent Application Publication
(10) Pub. No.: US 2025/0273013 A1
(43) Pub. Date: Aug. 28, 2025

(54) USER VERIFICATION USING FACIAL FEATURES

(71) Applicant: Valdimir Pte. Ltd., Singapore (SG)

(72) Inventors: Ying Kit Chan, Taikoo Shing (HK); Murtaza Gulamali Kanchwala, Taikoo Shing (HK)

(73) Assignee: Valdimir Pte. Ltd., Singapore (SG)

(21) Appl. No.: 18/636,193

(22) Filed: Apr. 15, 2024

(30) Foreign Application Priority Data
Feb. 27, 2024 (HK) 32024087709.4

(51) Int. Cl. G06V 40/40; G06V 40/16; G06V 40/60

(52) U.S. Cl. CPC G06V 40/45; G06V 40/165; G06V 40/172; G06V 40/174; G06V 40/60

(57) ABSTRACT

There is provided a computer implemented method, computer readable medium and system for verifying liveness of a subject depicted in a plurality of acquired images. An initial facial mesh is generated from multiple images in acquired images of the face of the subject. Further images are acquired subsequent to communicating to the subject a prompt indicative of an emotional state. A difference facial mesh is generated from facial landmarks extracted from a further image; and the change of some predetermined edges relative to corresponding edges of the initial facial mesh determined. A model trained by a machine learning algorithm evaluates whether the difference facial mesh corresponds to an expected emotional state for that subject following the prompt. The above steps are repeated and if a predetermined number of a difference meshes for a subject correspond to expected emotional states the subject is verified as live.

### BACKGROUND OF THE DISCLOSURE

(1) Field of the Invention: The present disclosure relates to verification of a user of a computer system, more specifically to a method and system for verifying that the user is physically present (live) using facial features.

(2) Description of Related Art: User authentication using biometric based techniques is becoming more widespread as additional or alternative means of user authentication to traditional password-based techniques. One typical approach using biometric user authentication is capturing one or more images of a subject's face and using these images to authenticate the user or subject. However, it would be appreciated that this approach can be vulnerable to facial forgery, whereby a third party may use photo or video of another in an attempt to fool the system.

Therefore, it is necessary for biometric face-based authentication techniques to utilise techniques for detecting the “liveness” or actual presence of the subject being authenticated. Various approaches have been utilised, including active techniques where the subject is required to interact with the system to perform specific actions or respond to prompts to confirm their presence; or passive techniques in which the user is not required to interact with the system. Such approaches may be performed by or supplemented with machine learning or advanced algorithms. Examples include blink detection, head movement detection, facial expression detection and hand gesture detection (active detection); or reflection/lighting analysis, texture analysis, 3D depth analysis or similar (passive detection).

Advanced facial expression analysis algorithms are utilized for active liveness detection, typically using a deep neural network architecture. However, this approach presents computational challenges for mobile or edge devices on which such analysis needs to be performed; especially since graphic processing units (GPUs) capable of executing such algorithms are not commonly integrated within mobile devices.

Alternatively, if a cloud-based environment is used, a considerable amount of image data must be transmitted from the edge device(s) to remotely located servers. It would be appreciated this requires time and consumes transmission bandwidth which may not always be consistently available. Therefore, the uninterrupted operation of the application is substantially reliant on the available bandwidth of the connection, particularly when processing high-resolution video data which is typically captured with a frame rate of 25 frames per second (fps).

Unfortunately, such problems associated with these approaches significantly compromise the effectiveness and implementation of liveness detection in user authentication approaches (especially active liveness detection). Accordingly, it is an object of the method and system of the present disclosure to address or at least partially ameliorate the above deficiencies.

### SUMMARY OF THE DISCLOSURE

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In accordance with a first aspect of the present disclosure, there is provided a computer implemented method for processing images of the face of a subject, the method comprising:
acquiring a first plurality of images of at least a portion of the face of a subject;
generating an initial facial mesh representative of said at least portion of the face of the subject by analysing multiple images of the first plurality of images to extract corresponding facial landmarks from each image of the subject and corresponding edges extending therebetween;
issuing a plurality of prompts to the subject indicative of predetermined emotional states;
acquiring a further plurality of images of at least a portion of the face of the subject after the issuance of each prompt;
generating a difference facial mesh for the subject after the issuance of each prompt by:
extracting a plurality of edges characterising the distance between facial landmarks of the subject from an image selected from the further plurality of images of the face of the subject;
generating a further facial mesh from said plurality of edges and facial landmarks;
determining change of at least some predetermined edges of the further facial mesh relative to corresponding edges of the initial facial mesh.

In another aspect there is provided a computer implemented method of verifying liveness of a subject depicted in a plurality of acquired images of the subject acquired at a first location comprising;
receiving over a network a plurality of difference facial mesh generated by a further processor at said first location following the issuance of a plurality of prompts indicative of an emotional state;
wherein each of said difference facial mesh is generated by:
acquiring a first plurality of image frames of the face of a subject
generating an initial facial mesh representative of at least portion of the face of the subject of the face of the subject by analysing multiple images of the first plurality of images to extract corresponding facial landmarks from each image of the subject and corresponding edges extending therebetween; and
acquiring a further plurality of images of the face of the subject subsequent to communicating to the subject said prompt;
generating a further facial mesh derived from a plurality of edges characterising the distance between facial landmarks of the subject extracted from an image randomly selected from the second plurality of images of the face of the subject;
determining the change of at least some predetermined edges of the further facial mesh relative to corresponding edges of the initial facial mesh;
evaluating by a model executing on one or more processors at a location remote from said first location; whether each of said received difference facial mesh corresponds to an expected emotional state for a subject following issuance of the prompt communicated to the subject; wherein said model is trained using a machine learning algorithm.

Said prompts may comprise an emoticon indicative of different emotional states a subject may experience. The emoticon may be displayed to the subject on the same portable electronic device used for acquiring images of the subject.

The emoticon may be indicative of an emotional state randomly selected from a group of predetermined emotional states.

Further steps of determining a scaling factor by calculating the distance between certain landmarks in the initial facial mesh for a subject and the distance between the same landmarks of the same subject in the further facial mesh; and applying said scaling factor in the comparison of other edges of the difference facial mesh with the initial facial mesh of that subject.

The image selected for the determination of the difference facial mesh may be selected randomly or according to predetermined criteria from the further plurality of acquired images.

The machine learning algorithm may be a classifier trained to identify all of the emotional states of the subject in the sets of images of the subject

In yet a further aspect there is provided a system for processing images of the face of a subject comprising one or more processors configured for
acquiring by an imaging apparatus in communication with the one or more processors a first plurality of images of at least a portion of the face of a subject;
generating by the one or more processors an initial facial mesh representative of said at least portion of the face of the subject by analysing multiple images of the first plurality of images to extract corresponding facial landmarks from each image of the subject and corresponding edges extending therebetween;
issuing by the one or more processors a plurality of prompts to the subject indicative of predetermined emotional states;
acquiring by the imaging apparatus a further plurality of images of at least a portion of the face of the subject after the issuance of each prompt;
generating by the one or more processors one or more difference facial mesh for the subject after the issuance of each prompt by:
extracting a plurality of edges characterising the distance between facial landmarks of the subject from an image selected from the further plurality of images of the face of the subject;
generating a further facial mesh from said plurality of edges and facial landmarks; determining the change of at least some predetermined edges of the further facial mesh relative to corresponding edges of the initial facial mesh.

Advantageously, each step is performed by one or more processors of a portable electronic device having an image acquisition means for acquiring images of the face of the subject.

In a further aspect there is provided a system for verifying liveness of a subject depicted in a plurality of acquired images of the subject comprising:
receiving over a network a plurality of difference facial mesh generated by a further processor at a first location following the issuance of a plurality of prompts indicative of an emotional state;
wherein each difference facial mesh is generated at said first location by a processor of an electronic device performing the steps of:
acquiring a first plurality of image frames of the face of a subject
generating an initial facial mesh representative of at least portion of the face of the subject of the face of the subject by analysing multiple images of the first plurality of images to extract corresponding facial landmarks from each image of the subject and corresponding edges extending therebetween; and
acquiring a further plurality of images of the face of the subject subsequent to communicating to the subject said prompt;
generating a further facial mesh derived from a plurality of edges characterising the distance between facial landmarks of the subject extracted from an image randomly selected from the second plurality of images of the face of the subject;
determining the change of at least some predetermined edges of the further facial mesh relative to corresponding edges of the initial facial mesh;
evaluating by a model executing on one or more processors at a location remote from said first location; whether each of said received difference facial mesh corresponds to an expected emotional state for a subject following issuance of said prompt communicated to the subject; wherein said model is trained using a machine learning algorithm.

Each step may be performed by one or more processors of a portable electronic device having an image acquisition means for acquiring images of the face of the subject.

The step of evaluating by the machine learning algorithm may be performed after transmission of each difference facial mesh over a network to by a processor of one or more remotely located servers.

In a further aspect there is provided a computer implemented method of training a learning model to determine the emotional state of a subject from images capturing at least a portion of the face of said subject; the method comprising:
acquiring a first plurality of images of at least a portion of the face of a subject;
generating an initial facial mesh representative of said at least portion of the face of the subject by analysing multiple images of the first plurality of images to extract corresponding facial landmarks from each image of the subject and corresponding edges extending therebetween;
issuing a plurality of prompts to the subject indicative of predetermined emotional states;
acquiring a further plurality of images of at least a portion of the face of the subject after the issuance of each prompt;
generating one or more difference facial mesh for the subject after the issuance of each prompt by:
extracting a plurality of edges characterising the distance between facial landmarks of the subject from an image selected from the further plurality of images of the face of the subject;
generating a further facial mesh from said plurality of edges and facial landmarks;
determining the change of at least some predetermined edges of the further facial mesh relative to corresponding edges of the initial facial mesh.
using a machine learning algorithm to train a model to associate the difference facial mesh of the subject with an expected emotional state for that subject following said prompt; and repeating each of the above steps for a plurality of subjects.

Advantageously, at least some of the prompts are emoticons indicative of various emotional states a subject may experience.

Preferably said emoticons are displayed on the same portable electronic device used for acquiring images of the subject.

Optionally said emoticons are each indicative of an emotional state randomly selected from a group of predetermined emotional states.

Preferably the first prompt is an emoticon and the at least one further prompt is a different emoticon.

Optionally a scaling factor may be determined by calculating the distance between landmarks in the initial facial mesh for a subject and the distance between the same landmarks of the same subject in the further facial mesh; and applying said scaling factor in the comparison of other edges of the difference facial mesh with the initial facial mesh of that subject.

Preferably the image selected for the determination of the difference facial mesh is selected randomly or according to predetermined criteria from the further plurality of acquired images.

In a further aspect, there is provided a non-transitory computer readable storage medium storing a plurality of instructions executable by one or more processors, the plurality of instructions when executed by the one or more processors, cause the one or more processors to perform the computer implemented method steps described herein.

In further aspects there is provided a computer implemented method of verifying liveness of a subject depicted in a plurality of acquired images of the subject, the method comprising:
(a) generating an initial facial mesh of at least a portion of the face of the subject, wherein said initial facial mesh is a derived from a plurality of corresponding edges between the same facial landmarks of the subject, said facial landmarks being extracted from multiple images selected from a first plurality of acquired images of the face of the subject; and
(b) acquiring a further plurality of images of at least the same portion of the face of the subject subsequent to communicating to said subject a prompt indicative of an emotional state;
(c) generating a difference facial mesh by
generating a further facial mesh derived from a plurality of edges characterising the distance between facial landmarks of the subject extracted from an image selected from the further plurality of images of the face of the subject;
determining the rate of change of at least some predetermined edges of the further facial mesh relative to corresponding edges of the initial facial mesh;
(d) evaluating by a model trained using a machine learning algorithm whether the difference facial mesh corresponds to an expected emotional state for that subject following said prompt;
(e) repeating steps (b) through to (d) to acquire still further pluralities of images of at least a portion of the face of the subject following communication of one or more prompts indicative of at least one or more further emotional states to the subject;
wherein if a predetermined number of a difference meshes for a subject are identified as corresponding to expected emotional states for that subject following said prompts, the subject is verified as live.

Still further there may be provided a system for verifying liveness of a subject depicted in a plurality of acquired images of the subject comprising:
one or more processors configured for
(a) acquiring images via an imaging acquisition means for generating an initial facial mesh representative of the face of the subject, said initial facial mesh wherein said initial facial mesh is a derived from a plurality of corresponding edges between the same facial landmarks of the subject, said facial landmarks being extracted from multiple images selected from a first plurality of acquired images of the face of the subject; and
(b) acquiring a second plurality of images of the face of the subject subsequent to communicating to the subject at least a further prompt indicative of a first emotional state;
(c) generating a difference facial mesh by generating a further facial mesh derived from a plurality of edges characterising the distance between facial landmarks of the subject extracted from an image selected from the second plurality of images of the face of the subject; and determining the rate of change of at least some predetermined edges of the further facial mesh relative to corresponding edges of the initial facial mesh;
a remotely located server having further one or more processors configured for evaluating by a model trained using a machine learning algorithm whether one or more difference facial mesh received from the portable electronic device across a network corresponds to an expected emotional state for that subject following one or more prompts;
wherein upon a predetermined number of a difference meshes for a subject being identified by said model as corresponding to expected emotional states for that subject following issuance of successive prompts, the subject is verified as live.

In yet another aspect there is provided a non-transitory computer readable storage medium storing a plurality of instructions executable by one or more processors, the plurality of instructions when executed by the one or more processors, cause the one or more processors to:
(a) acquire a first plurality of image frames of the face of a subject
(b) generate an initial facial mesh representative of the face of the subject, wherein said initial facial mesh is a derived from a plurality of corresponding edges between the same facial landmarks of the subject, said facial landmarks being extracted from multiple images selected from a first plurality of acquired images of the face of the subject; and
(c) acquire further plurality of images of the face of the subject subsequent to communicating to the subject a prompt indicative of a first emotional state;
(d) generate a difference facial mesh by
   (i) generating a further facial mesh derived from a plurality of edges characterising the distance between facial landmarks of the subject extracted from an image selected from the further plurality of images of the face of the subject;
   (ii) determining the rate of change of at least some predetermined edges of the further facial mesh relative to corresponding edges of the initial facial mesh.

In still a further aspect there is provided a non-transitory computer readable storage medium storing a plurality of instructions executable by one or more processors at a first location, wherein the plurality of instructions when executed by the one or more processors cause the one or more processors to:
receive over a network a difference facial mesh generated by a further processor remote from said first location; said difference facial mesh being generated by the further processor by:
acquiring a first plurality of image frames of the face of a subject
generating an initial facial mesh representative of the face of the subject, wherein said initial facial mesh is a derived from a plurality of corresponding edges between the same facial landmarks of the subject, said facial landmarks being extracted from multiple images selected from a first plurality of acquired images of the face of the subject; and
acquiring a further plurality of images of the face of the subject subsequent to communicating to the subject a first prompt indicative of a first emotional state;
generating a further facial mesh derived from a plurality of edges characterising the distance between facial landmarks of the subject extracted from an image randomly selected from the second plurality of images of the face of the subject;
determining the rate of change of at least some predetermined edges of the further facial mesh relative to corresponding edges of the initial facial mesh;
evaluating by a model executing on the one or more processors at the first location; whether the received difference facial mesh corresponds to an expected emotional state for a subject following issuance of a predetermined prompt; wherein said model is trained using a machine learning algorithm.

In another aspect there is provided a computer implemented method of training a learning model to determine the emotional state of a subject from images capturing at least a portion of the face of said subject;
the method comprising:
generating an initial facial mesh of at least a portion of the face of a first subject, wherein said initial facial mesh is a derived from a plurality of corresponding edges between the same facial landmarks of said first subject, said facial landmarks being extracted from multiple images selected from a first plurality of acquired images of the face of the subject; and
acquiring a further plurality of images of at least the same portion of the face of the subject subsequent to communicating to said subject a prompt indicative of an emotional state;
generating a difference facial mesh by
generating a further facial mesh derived from a plurality of edges characterising the distance between facial landmarks of the subject extracted from an image selected from the further plurality of images of the face of the subject;
determining the rate of change of at least some predetermined edges of the further facial mesh relative to corresponding edges of the initial facial mesh;
using a machine learning algorithm to train a model to associate the difference facial mesh of the subject with an expected emotional state for that subject following said prompt;
repeating each of the above steps for a plurality of subjects.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended Figures. Understanding that these Figures depict only exemplary embodiments of the disclosure and are not therefore to be considered to be limiting of its scope, the principles herein are described and explained with additional specificity and detail through the use of the accompanying Figures.

Preferred embodiments of the present disclosure will be explained in further detail below by way of examples and with reference to the accompanying Figures, in which:

FIG. 1A depicts an exemplary schematic system architecture in accordance with an embodiment of the present disclosure;

FIG. 1B depicts an alternative exemplary system architecture in accordance with a further embodiment of the present disclosure;

FIG. 2A depicts an exemplary flowchart showing the overall steps of an embodiment of the present disclosure;

FIG. 2B depicts an exemplary pictorial flowchart outlining steps undertaken by the electronic device for the embodiments depicted in both FIGS. 1A and 1B;

FIG. 3A depicts an exemplary schematic representation of facial landmarks identified for an exemplary user;

FIG. 3B depicts an exemplary mesh formed from the facial landmarks identified in FIG. 3A;

FIG. 4A depicts an exemplary image of a the subject;

FIG. 4B depicts an exemplary initial facial mesh which is generated from a series of images of the same subject as that depicted in FIG. 4A.

FIG. 4C depicts an enlarged portion of the facial mesh of FIG. 4B;

FIG. 4D depicts a schematic representation of five exemplary facial landmarks within the circled region of the facial mesh of FIG. 4C;

FIG. 5A depicts an exemplary image of the same subject depicted in FIG. 4A with a surprised expression;

FIG. 5B depicts an exemplary facial mesh derived from the image of FIG. 5A;

FIG. 5C depicts an exemplary enlarged portion of the facial mesh of FIG. 5B;

FIG. 5D depicts a schematic representation of the same five exemplary facial landmarks, except this time derived from the image captured in FIG. 5A (surprised expression);

FIG. 6 depicts an exemplary representation of emoticons which may be displayed to the user;

FIG. 7A depicts a corresponding plot of accuracy against number of epochs; and

FIG. 7B depicts an exemplary graph showing the validation loss and number of epochs for the machine learning model employed in the present disclosure.

### DETAILED DESCRIPTION OF THE EXEMPLARY EMBODIMENTS

Various embodiments of the disclosure are discussed in detail below. While specific implementations are discussed, it should be understood that this is done for illustration purposes only. A person skilled in the relevant art will recognize that other components and configurations may be used without departing from the spirit and scope of the disclosure.

The disclosed technology addresses the need in the art for a liveness detection approach in user authentication involved in electronic “Know You Client” processes; which is engaging, efficient and reliable for the subjects undertaking the detection process.

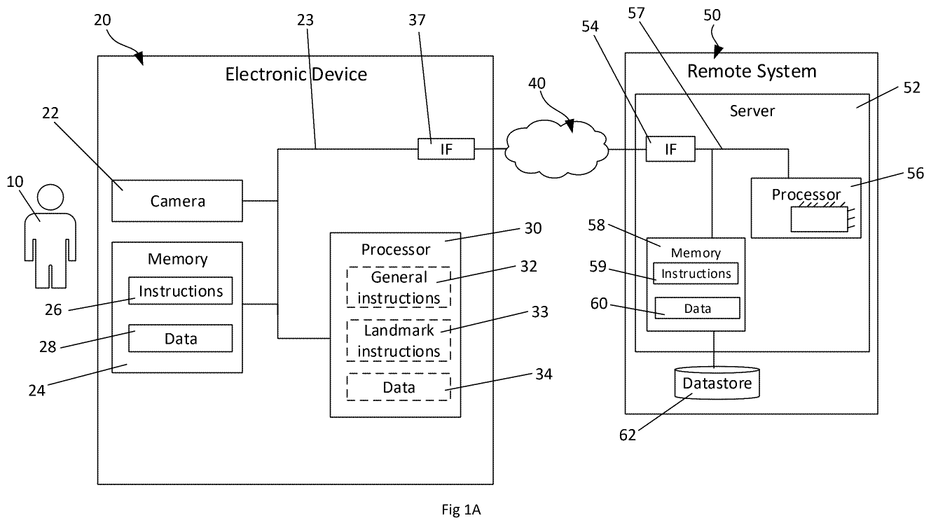

Referring to FIG. 1A, there is depicted a user 10, operating an electronic device 20 which communicates data across a wired or wireless network 40 with a remotely located server system 50. Referring next to FIG. 1B, this Figure depicts a similar system to FIG. 1A except that in the system depicted in FIG. 1B, there is no remotely located server 50; and all processing is performed on the electronic device.

As described further herein, the present disclosure may operate on the schematic architecture or similar as depicted in FIG. 1A, or in the stand-alone architecture depicted in FIG. 1B.

Advantageously, it would be appreciated that in the system depicted in FIG. 1A; the data retained in the data store 62 (including data models and machine learning algorithms) is not readily available.

As depicted the exemplary electronic device 20 includes a camera or image acquisition means 22 through which a user 10 is able to easily capture images and/or video footage of their face. For example, the camera or image acquisition means 22 may be a front facing camera which is integrated in a smart phone tablet or laptop computer screen or an external webcam which is mounted on said laptop or desktop display screen without restriction.

The camera 22 is advantageously connected by a bus 23 with the other components of the electronic device 20. These components may include memory 24 which may include stored non-volatile memory which retains machine-readable instructions 26 and data 28 when the power is switched off. This memory 24 is connected via the bus 23 with the other components of the electronic device 20 including the processor 30; said processor being configured to read and execute machine readable instructions 32; and perform facial landmark extraction and difference mesh creation according to stored instructions 33 described further herein together with other data 34 from the memory 24.

The device 20 includes an interface 37 which connects transmitter and receiver modules therein with the network 40.

Communications between the electronic device 20 and the remotely located system 50 over the network 40 may be mediated at the remote server 52 via the interface 54, and at the device via the interface 37. It would be appreciated that as depicted, the remotely located server 52 may comprise a processor 56 and memory 58 in which instructions 59 and data 60 may be stored for subsequent execution by the processor 56.

A data store 62 may contain the trained machine learning algorithm which is executed by the processor 56 for evaluating the data representing the change in expressions of the subject relative to the at rest facial position of that subject responsive to the prompt in the embodiment of the system depicted in FIG. 1A.

Preferably, in the embodiment depicted in FIG. 1A, the data representing the change in expressions of the subject relative to the at rest facial position of that subject responsive to the prompt in the embodiment is transmitted across the network 40 from the remote electronic device as described further herein. Advantageously the machine learning algorithm trains a model which can determine if the change in facial expression of users following issuance of a prompt is consistent with an expected emotional state as is described further herein.

Alternatively, as depicted in the arrangement shown in FIG. 1B, the trained model may be provided to and operate on the same device on which the images of the subject are captured.

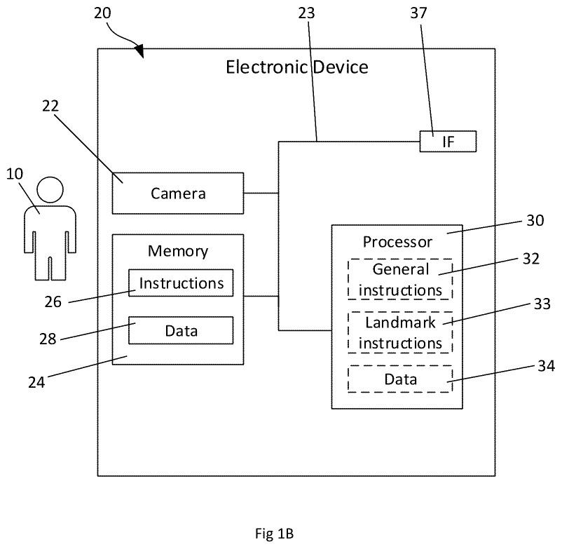

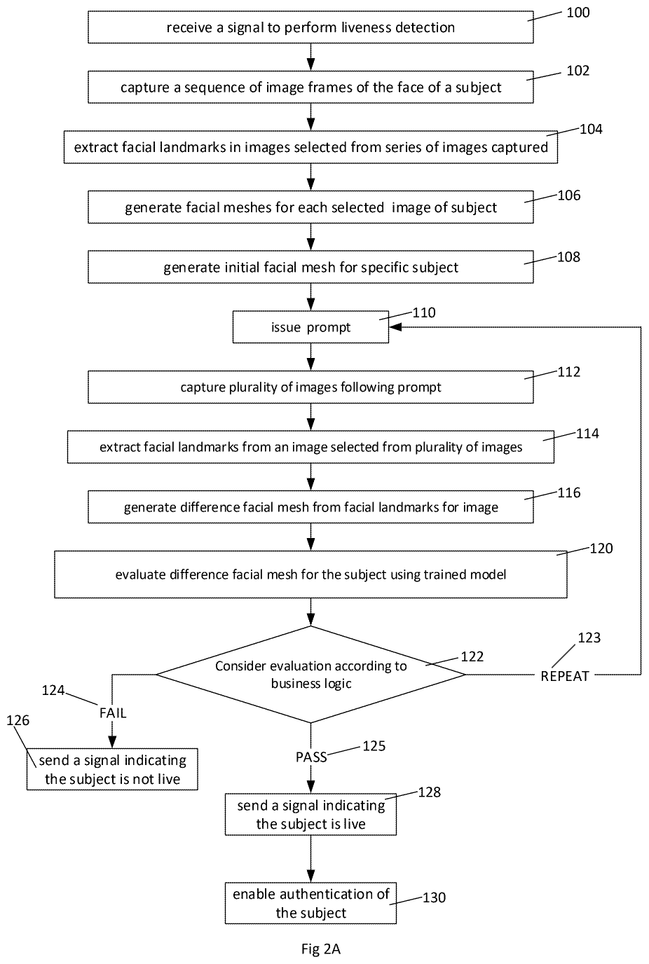

Reference is made to FIG. 2A which is a flowchart which depicts the processes and steps of the present disclosure; and to FIG. 2B which depicts certain key steps of the processes in a more pictorial representation.

As would be appreciated, the present disclosure may be initiated as part of the electronic “know your client”. As depicted, in step 100 of FIG. 2A a signal is received to perform face liveness detection, which may be commonly initiated based on a facial recognition-based authentication. This signal is advantageously provided from onboarding software prior to embarking on the other steps in the user onboarding process, since if the user does not pass the liveness test, there is no need to continue with subsequent stages such as verifying the subject against a photographic ID and other stages in the subject setup process.

In step 102 as depicted in FIG. 2A and FIG. 2B, a series of image frames of the face of a potential subject are captured, preferably by the camera of the portable electronic device preferably by capturing video images. As the typical frame rate for video capture on a portable electronic device is 25 frames per second it is not necessary to capture video of a long duration. Alternatively, multiple static images could also be acquired, although this approach maybe more onerous for the potential subject as their facial expression has more likelihood of changing expression given the time between frames and may not provide a properly indicative “expressionless face” despite the aggregation discussed below.

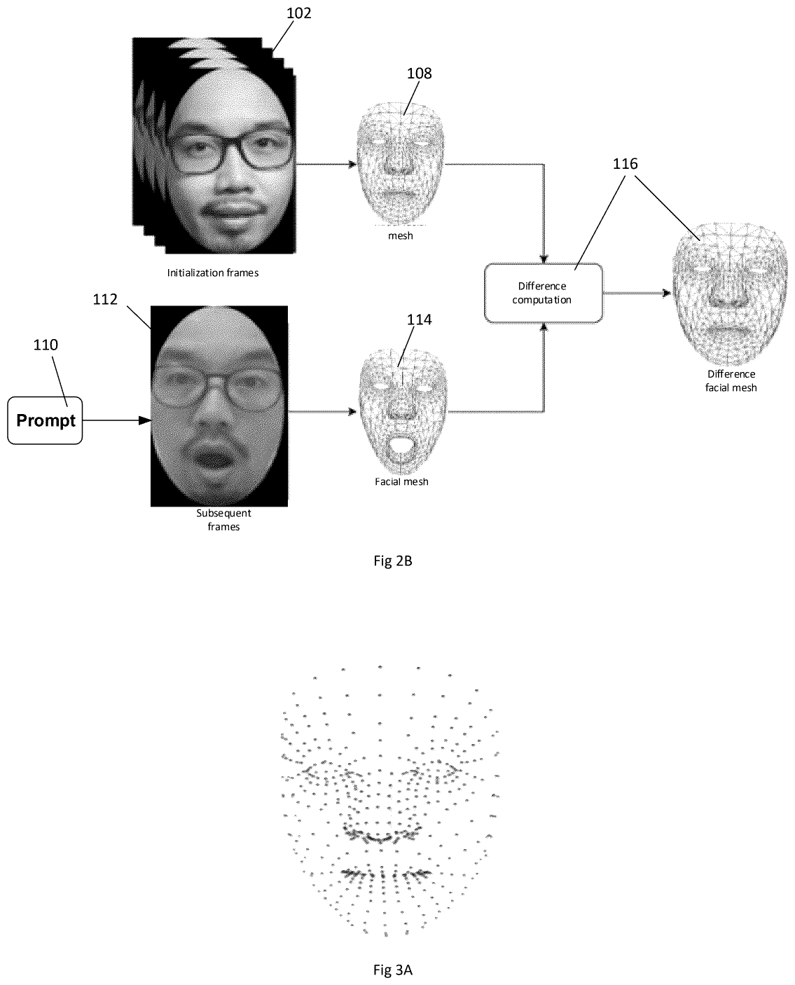

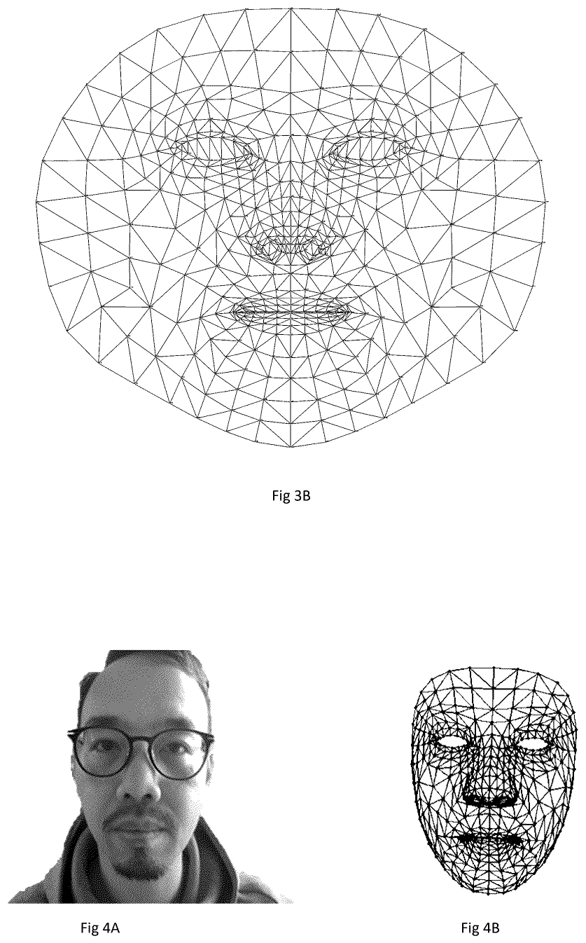

Next in step 104, facial landmarks are identified in selected images of the subject, advantageously these images being randomly selected from the acquired images in the captured video footage. Such facial landmarks may include 468 facial landmarks in accordance with established approaches used in facial image recognition. It would be appreciated that the estimation of these landmarks is performed in a three-dimensional space which means that each facial landmark is represented by X, Y, and Z coordinates. An exemplary representation of such facial landmarks is depicted in the schematic diagram shown in FIG. 3A.

Importantly, it is at this point that the present disclosure diverges from the approaches in the art which may analyse all pixels in each successive image to determine liveness. By contrast to other prior art approaches, the present disclosure approximates the position of the facial landmarks of the subject and analyses the changes in the edges interconnecting such landmarks instead of the position of the pixels themselves; in an approach disclosed further herein.

Advantageously, the various facial landmarks identified according to the present disclosure can be used as the basis for the generation of a triangle or similar facial mesh using a shape to interconnect shared edges and vertices as depicted in step 106. An exemplary facial mesh produced from this process is depicted in FIG. 3B.

In an exemplary embodiment this facial mesh may be a triangular mesh comprising 2556 edges that connect facial landmarks, although it would be appreciated that other facial meshes could also be generated without departing from the scope of the present disclosure with different numbers of landmarks and edges and underlying polygons used to represent the interconnections.

It would be appreciated that if fewer facial landmarks are specified in advance, there will be a reduced number of associated edges. Advantageously, the number of edges may be reduced by excluding “non-essential landmarks” determined by measuring the magnitude of length changes of the edges connecting to each landmark when the user reacts to a prompt as described further herein.

It has been identified that the facial meshes generated for the landmarks of a subject may vary from frame to frame as the subject may have some facial expressions during the image acquisition process, or may move etc. This means if a single image was used from which landmarks were extracted and a facial mesh representative of that subject generated, inconsistencies or the actual emotional state of the subject when the image captured could mean that this mesh is not truly representative of the “resting” facial mesh or position of facial landmarks for that subject. If the resting or initial facial mesh is used is not truly indicative of the actual “resting” or neutral facial mesh for that subject it would be appreciated that this would reduce the accuracy of the subsequent determination of facial expression of the subject relative to this initial facial mesh.

Accordingly, in the present disclosure an “initial” facial mesh is generated for the subject from a series of randomly selected images extracted from a series of frames (advantageously a video comprising sequential images of the face of the subject). Importantly, it should be noted that this process of generating a facial mesh for each image selected from the series of may only involve a relatively computationally lightweight machine learning algorithm. Advantageously, the specific images may be selected from the series of images randomly, or after a certain number of images without limitation. It would be appreciated that various facial landmark extraction approaches could be used without limitation. Advantageously, the MediaPipe® framework or similar may be used.

Preferably the initial facial mesh may be generated by weighting corresponding edges in a plurality of successive images for the same subject. Advantageously, this weighting may be performed by determining the average length of each line connecting each landmark in each of the facial meshes generated for the selected images of that subject. The selected images may be may be referred to as the initialisation frames. Other techniques in addition to the averaging technique described herein may be used to generate a representative initial facial mesh which smooths out facial expressions and takes into account the fact that some of the images acquired of the subject may have facial expressions. It would be appreciated that the more images used in determination of the initial face mesh the better the representation will be as it is less affected by variance in individual images.

Next, an exemplary facial initial mesh for the face of the specific subject may be generated in step 108 and stored.

Subsequently, in step 110, a prompt may be issued to the subject. The prompt may be in the form of an emoticon or provided in alternative format such as text, icon, audio, pictures, movies etc. without limitation. Advantageously, the prompt is associated with emotional states of the subject which are linked to changes in facial expression. An exemplary set of emoticons is provided as FIG. 6, in which the various emotional states and facial expressions are represented in emoticon format. Providing the prompts in an emoticon format such as that depicted enhances the usability of the process and hence engagement,

In step 112, following issuance of a prompt, short videos or series of image frames may be captured of the facial expressions of the subject displaying emotional states linked with the prompt. For example, the subject may be supplied with a prompt to show their corresponding facial expression when they are angry, sad, happy, surprised or grimacing or other such emotional states without limitation.

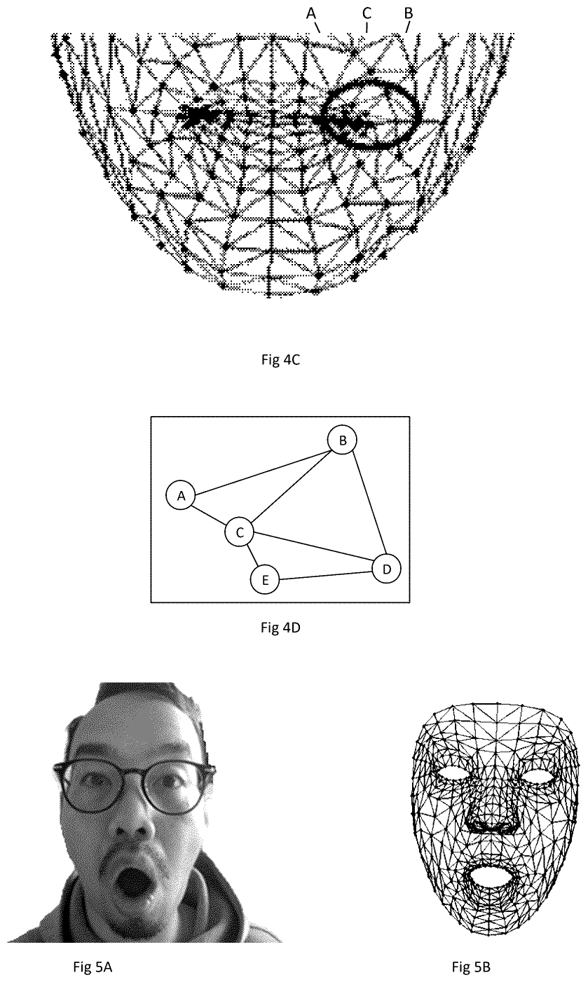

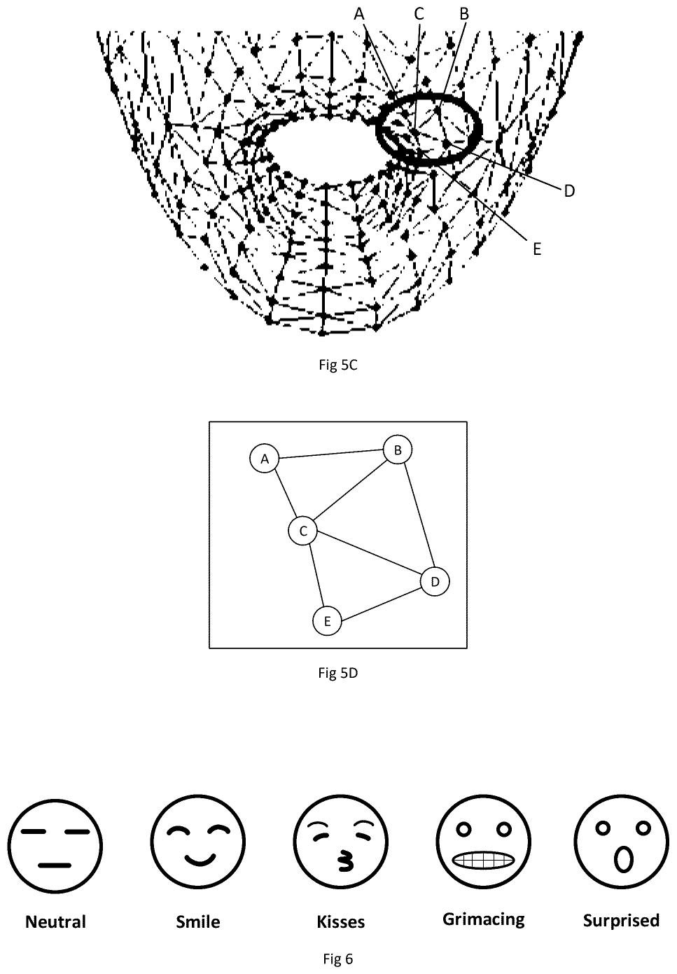

It can be seen by a human reviewer that when the facial expression of the single image of subject depicted in FIG. 4A, is compared to the facial expression of the image of the same subject in FIG. 5A, the subject appears surprised.

Next, in step 114 the facial landmarks from the image selected may be extracted in an analogous process to that discussed above in step 104. The image may be selected randomly or according to predetermined criteria (e.g. the 10^{th} frame or after 2 seconds or some other setting).

Advantageously, in step 116, a difference mesh of the subject's facial features (or a subset of the subject's facial features) may then be determined for each image selected from the subset of images captured following the prompt issuance. All of the facial edges in the initial mesh (and hence difference facial mesh) could be generated for the various image subsets.

However, it is also possible to specify that the edges are generated between certain facial landmarks in certain facial portions only; these edges being associated with the facial expressions of subjects experiencing various emotional states. It would be appreciated that this approach reduces further the bandwidth and computational power required on the edge device and or server as appropriate.

In the embodiment depicted in FIG. 1A, difference facial mesh(es) be transmitted from an edge device over a network 40 to the remotely located server for evaluation by a trained machine learning algorithm machine learning algorithm. This algorithm evaluates using a trained model whether the respective edges of that difference mesh correspond to respective edges of the difference mesh expected for the facial expression of that subject; and which is associated with the anticipated emotional state following the prompt.

It is not necessary that the underlying initial mesh of the subject is also transmitted, as it is sufficient that the difference facial mesh (showing the relative change of the subject to their initial facial mesh) is transmitted.

Alternatively, if the arrangement is as depicted in FIG. 1B, where the machine learning algorithm is also executed on the edge device, there is no need for transmission of the difference mesh across the network to a server having the machine learning algorithm and model, as this may be processed on the same edge device on which the image is captured.

Preferably, the classification model is designed for the identification and differentiation of the above-defined facial expressions, using distinct facial expressions which engage various muscle groups on the human face. Consequently, these unique muscle activations can be represented and distinguished using the difference facial mesh.

Advantageously, the difference facial mesh(es) are derived by computing differences in the lines (edges) of the initial facial mesh generated for the subject and the extracted mesh of the subsequent image. This enables identification of lines/edges with a higher degree of change and therefore which become more prominent in the consideration by the classifier. This approach to generation of difference mesh herein described facilitates the construction of a highly accurate classifier, even when constrained by a limited dataset which can perform an evaluation as indicated at step 120.

As such, the difference facial mesh evaluated is a representation of or proxy for illustrating the contraction and relaxation of facial muscles in different facial expressions. This feature representation is more efficient than the traditional approach of using a convolutional neural network to discover facial features by combining pixels in RGB channels. By directly representing the underlying muscle movements, the difference facial mesh approach of the present disclosure provides a more accurate and biologically plausible model for facial expression analysis.

Furthermore, it would be appreciated that the difference mesh approach provides a fixed dimensionality corresponding to the total number of edges in the facial mesh (e.g. in the example described this was 2,556 but other constrained edges would be also possible if the landmarks/mesh were changed). As such, the computational complexity of the model is remarkably low compared to deep Convolutional Neural Network (CNN) architectures. This reduced complexity enables the use of a simple Multilayer Perceptron (MLP) model or even traditional statistical models such as Support Vector Machines (SVM). Hence, this approach does not require a machine equipped with a Graphics Processing Unit (GPU) for either model training or inferencing operations.

Depending on the outcome of the evaluation of the difference facial mesh against the initial facial mesh for that subject based on pre-configured business logic, there are a number of possible branches which may occur next as depicted in step 122.

If the model identifies the difference mesh analysed corresponds to the anticipated facial expression associated with the emotional state of that subject, the system may be configured to provide one or more subsequent prompts to the subject and the process of generating a new difference mesh from an image of the subject following a new prompt selected from a video (comprising a series of image frames) or from successive acquired image(s) of that subject can be repeated as indicated by step 123. The steps of issuing a prompt, difference mesh generation and evaluation may be repeated a number of times, to satisfy predetermined numbers of iterations specified by the system administrator.

Alternatively, as depicted, in step 124, the threshold of unsuccessful identifications of emotional state following a prompt has been exceeded (e.g. after processing three, five or more images, and the model determines that none or an insufficient number match the expected emotional state), In such as case, as depicted by step 126, signal indicating that the face is not live or an error has been detected may be issued or some other notification issued.

In yet another alternative, as denoted by 125, the facial expression of a subject in an image following a prompt may have been successfully verified as indicating the anticipated emotional state for that subject following that prompt, and this successful verification has been repeated a predetermined number of times, and therefore, this may be considered successful verification of liveness.

For example, an authorised operator may configure the system such that three prompts, with three successful verifications in a row; (with no more than three attempts for each prompt) may be required for a successful verification. It would be appreciated that alternative numbers of prompts, numbers of successful verifications in a row; and maximum number of attempts could be specified without restriction.

If successful verification of liveness has taken place (the difference facial mesh is determined to meet the expected difference following the prompt by the classifier, which has been repeated for a predetermined number of prompts; within the acceptable level of attempts) as depicted in step 128, a signal may be provided that the images of the subject face which have been acquired are live.

As depicted in step 130, the other steps in the authentication and creation of a subject profile may then occur. The subsequent steps may include the provision of a user photographic ID such as a driver's license, identification card, passport or the like.

The facial features of the verified live user and captured by the camera in the current session can then be compared to the image of the identity document. Of course, it would be appreciated that other subsequent steps may also be implemented in the subject creation process, in the electronic know-your-client procedure according to the necessary processes of the organisation.

As noted above, the classification may be performed either on the edge device (e.g. smartphone) or by the server.

In an exemplary trial of the trained classifier according to the present disclosure on a number of different Apple iPhone® portable smart phones the following respective execution times were noted:

TABLE 4
Execution times for difference mesh classifier

Execution time (ms)

| iPhone ® | Client-side | Server-side |
|---|---|---|
| Models | Classifier | Classifier |
| 11 Pro Max | 37.04 | 27.78 |
| 12 Pro Max | 32.26 | 26.32 |
| 13 | 31.25 | 27.78 |
| 14 Pro | 25.64 | 23.26 |

Referring to FIG. 4A, there is depicted an exemplary image of a subject which has been acquired in an embodiment of the present disclosure by a portable electronic device such as a smart phone. FIG. 4B depicts the exemplary facial mesh generated from the image of this particular subject. A number of such images and facial meshes generated from a first plurality of acquired images may then be utilised to generate the initial facial mesh as described above.

It would be appreciated that the actual initial facial mesh of the subject may differ slightly from the facial mesh depicted in FIG. 4B which is just one instance of a facial mesh generated from one image of the subject.

Referring to FIG. 4C, there is an enlarged version of a portion of the facial mesh of FIG. 4B, in which five key facial landmarks are denoted by the letters ABCDE.

FIG. 4D depicts a schematic version of the edges and vertices derived from such facial landmarks in a certain spatial orientation with respect to each other for that facial mesh generated from that frame for the specified subject. It should be appreciated that although the full facial meshes are depicted in the embodiment described with reference to FIGS. 4A-4D, predetermined portions of the face of a subject may also be utilised without departing from the scope of the present disclosure. Furthermore, it would be appreciated that although five facial landmarks are denoted in the particular region, alternative numbers and arrangements of facial landmarks could also be identified for the same portion of the face of the subject.

TABLE 1

| Edge between | | |
|---|---|---|
| Node X | Node Y | Distance |
| A | B | 3.5 |
| A | C | 0.4 |
| B | C | 3.1 |
| B | D | 3.4 |
| C | D | 3.2 |
| C | E | 0.2 |
| D | E | 2.4 |

Table 1 shows the length of the edges on FIG. 4D. Similar evaluations for images of the same subject are performed to determine an initial facial mesh, as an average or aggregate or otherwise representative of multiple facial meshes from which this initial facial mesh is derived.

Further continuing with the example, an exemplary facial mesh generated from the image depicted in FIG. 5A is represented in FIG. 5B. An enlarged portion of the facial mesh of FIG. 5B is depicted in FIG. 5C, with the same five facial landmarks identified with the letters ABCDE.

A schematic representation of the same five facial landmarks depicted in FIG. 4D can be seen in FIG. 5D. It can be seen that such landmarks have a different spatial orientation with respect to each other; and it would be appreciated that the difference with facial landmarks of an initial facial mesh for the subject could also be determined. The relative change of these spatial orientations between the selected image frames relative to the initial facial mesh of that subject may then be derived by comparing the lengths of corresponding edges of the derived facial mesh and the initial facial mesh, advantageously by determining a ratio as depicted below in Table 3.

TABLE 2

| Edge between | | |
|---|---|---|
| Node X | Node Y | Distance |
| A | B | 2.8 |
| A | C | 0.8 |
| B | C | 3 |
| B | D | 3.4 |
| C | D | 3.3 |
| C | E | 1 |
| D | E | 2.9 |

Table 2 above shows the length of the corresponding edges between facial landmarks of the portion of the image of the subject depicted in FIG. 5D. Advantageously, the same edges between the same facial landmarks are evaluated for the same subject (albeit with a different expression) as those depicted in FIG. 4D.

TABLE 3

| | | Initial | Subsequent | Difference |
|---|---|---|---|---|
| Edge between | | facial mesh | facial mesh | facial mesh |
| Node X | Node Y | length | length | relative change |
| A | B | 2.8 | 2.2 | 0.8 |
| A | C | 0.8 | 1.6 | 2 |
| B | C | 3 | 2.9 | 0.96 |
| B | D | 3.4 | 3.4 | 1 |
| C | D | 3.3 | 3.4 | 1.03 |
| C | E | 1 | 5.0 | 5 |
| D | E | 2.9 | 3.5 | 1.21 |

Table 3 above shows the length of the edges determined for the “Difference Mesh” on the portion of the image of the subject depicted in FIG. 5D.

It would be appreciated that multiple images of the subject's face in an initial rest position such as that depicted for FIGS. 4A-4D are processed to determine the initial facial mesh measurements as described herein. If the difference facial mesh is determined with respect to one image this has been determined to be error prone in implementation due to possibility of a facial expression being captured in the “neutral expression” image. To avoid this, an aggregate initial facial mesh is used as described herein.

Hence, the method of the present disclosure is similar to the comparison between the edges described above between FIGS. 4A-4D and 5A-5D; with the calculation is between landmarks of a number of images to derive a representative initial facial mesh as described herein; and the difference facial mesh generated, advantageously as a ratio between corresponding edges in a further facial mesh relative to edges in the initial facial mesh.

At this point, it is important to note that the location of the subject relative to the camera may have changed, which means the measured distance of the landmarks in the subsequently acquired facial expressions may be different from the measured distance between such landmarks on the face of the subject when the initial facial mesh for that subject is generated.

Accordingly, in order to compensate for potential relative movement of the subject to the camera, it is necessary to consider scaling the corresponding edges between facial landmarks of the subsequently acquired images such that they are equivalently scaled to the edges between the same landmarks of the underlying initial facial mesh of that subject.

It would be understood that in the context of a three-dimensional coordinate system, the computation of the distance between any two given points can be achieved through the employment of the following distance formula:

$$d ( P1 , P2 ) = \sqrt{{( {x}_{2} - {x}_{1} )}^{2} + {( {y}_{2} - {y}_{1} )}^{2} + {( {z}_{2} - {z}_{1} )}^{2}}$$

Where,
P1, and P2 denote the given point 1 and point 2 in the three-dimensional space. (x1, y1, z1) and (x2, y2, z2) denote the x, y, z coordination of points 1 and 2, respectively.

To account for the relative movement of the subject relative to the camera, the length of each edge between facial landmarks is calculated in relation to the initial facial mesh scale, rather than attempting to ascertain the precise distances between landmarks on the subject's face in subsequent capture. This eliminates the need for evaluating the actual distance between facial landmarks, thereby offering a more efficient and easier means of facial analysis.

A scaling factor is then used to maintain consistency in the representation of facial expressions in a three-dimensional facial mesh model, regardless of the subject's distance from the camera during an image acquisition session.

Advantageously, in an exemplary arrangement, one approach to addressing this issue was using the following steps:

1. Selecting a predetermined distance between two points on a specific subject's initial facial mesh, referred to as the “scaling line,” which serves as a reference for calculating the scaling factor throughout the entire session. Advantageously, this scaling line may be selected between landmarks for distances which are substantially invariant despite changing facial expressions e.g. such as the distance between a subject's nose and the top of their lip.

2. Upon receiving an image for inferencing, estimate the facial expression mesh corresponding to the subject's current facial expression.

3. Calculating the scaling factor by comparing the length of the scaling line on the estimated facial expression mesh to the length of the scaling line on the initial facial mesh.

4. Scaling each edge of the facial expression mesh using the calculated scaling factor, thereby adjusting the length of all edges in the facial expression mesh to match the spatial dimensions of the initial facial mesh, irrespective of the subject's proximity to or distance from the camera.

5. Computing the distances of a difference mesh by calculating the relative change of each edge in the facial expression mesh relative to the corresponding edge in the initial facial mesh.

By employing the above steps, the representation of facial expressions in a three-dimensional facial mesh model remains consistent and accurate, regardless of changes in the subject's position relative to the camera during a session. This approach enhances the reliability and robustness of facial expression analysis and recognition systems, particularly in applications where the subject's distance from the camera may vary over time.

This may be represented through the following equations.

$${d}_{x , y}^{f} ∈ {Mesh}^{f} , {d}_{x , y}^{i} ∈ {Mesh}^{i} \qquad ( 1 )$$

Mesh^{f} is the Foundation Mesh, and Meshⁱ is the Inferencing Mesh.
d_{x,y}^{f}, and d_{x,y}ⁱ denotes the distance between any two given points x and y in the Foundation Mesh, Inferencing Mesh, respectively.

$${scaler}_{x , y}^{f} ∈ {Mesh}^{f} , {scaler}_{x , y}^{i} ∈ {Mesh}^{i} \qquad ( 2 )$$

scaler_{x,y}^{f}, and scaler_{x,y}ⁱ denotes the length of the elected scaling line between point x and y in the Foundation Mesh and Inferencing Mesh, respectively.

$$sf = \frac{{scaler}_{x , y}^{i}}{{scaler}_{x , y}^{f}} \qquad ( 3 )$$

Scaling factor sf measures the magnitude of change of the selected scaling line.

$${Mesh}^{delta} = \frac{{Mesh}^{i} x sf}{{Mesh}^{f}} \qquad ( 4 )$$

The Delta Mesh^{delta} (difference mesh) is calculated for each subsequent frame obtained by adjusting the scale and subsequently comparing it to the Foundation Mesh derived for that subject.

In order to generate a dataset for training the model used for the machine learning algorithm, a data collection process was initiated for ten (10) personnel from the applicant's organization. The composition of the participant group comprised six (6) male and four (4) female individuals, ensuring a diverse representation of facial features and expressions.

The facial expressions of the participants from various angles and perspectives were captured, and participants were instructed to provide facial expressions having a range of magnitudes/degrees. This approach was designed to ensure a comprehensive and robust dataset, accounting for the inherent variability in human facial expressions.

Each participant was requested to provide a total of fifty (50) images per facial expression class, resulting in a substantial dataset. The resulting dataset, comprising 2,500 data points, enhanced the accuracy and effectiveness of the invention in recognizing and interpreting facial expressions across a diverse population.

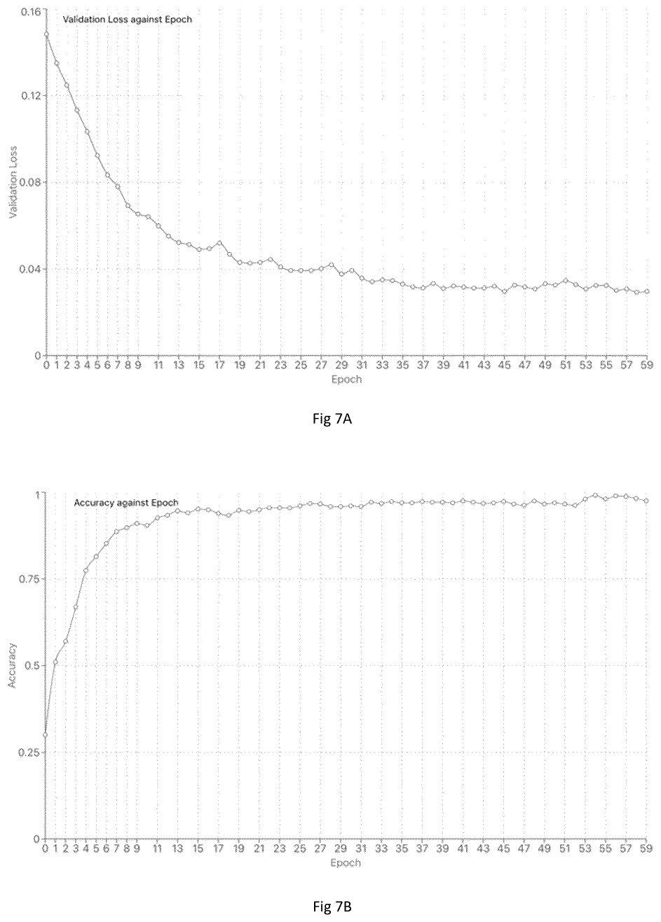

In FIGS. 7A and 7B, the accuracy and validation loss across epochs during the training of the facial expression classifier model are depicted. FIG. 7A shows a rapid convergence of the model's accuracy towards an optimal level within the initial 10 epochs. This suggests that the constructed model exhibits high efficiency in learning from the dataset. Thus this Figure demonstrates that following the formulation of the facial expression classification problem, utilizing the difference facial mesh effectively discriminates between various facial expression patterns.

As depicted in FIG. 7B, the validation loss demonstrates a significant trend, indicating that the model begins to generalize effectively after approximately 30 epochs. This trend clearly shows that the model is not succumbing to overfitting with respect to the provided dataset. The model's ability to avoid overfitting, while still achieving generalization post the 30-epoch mark, underscores overall robustness and adaptability, key characteristics that enhance its overall performance and reliability.

In the process of training the model, the data points were subjected to a randomization procedure, ensuring a thorough shuffling of the available data. Subsequently, the shuffled data was partitioned into two distinct sets: a training set, comprising 90% (equivalent to 2,250 data points) of the total data, and a validation set, constituting the remaining 10% (equivalent to 250 data points).

Partitioning facilitated the evaluation of the model's performance and generalization capabilities. Upon completion of the training process, the model demonstrates an accuracy rate of 92% when applied to the validation data set.

To further elucidate the model's performance at the class level, a confusion matrix is provided in Table 5. This matrix serves as a visual representation of the model's accuracy in predicting each class.

TABLE 5
Confusion Matrix

| | | Ground Truth | | | | |
|---|---|---|---|---|---|---|
| | | Neutral | Smile | Kisses | Grimacing | Surprised |
| Prediction | Neutral | 44 | 0 | 4 | 0 | 2 |
| | Smile | 0 | 49 | 0 | 1 | 0 |
| | Kisses | 1 | 3 | 46 | 0 | 0 |
| | Grimacing | 0 | 0 | 2 | 49 | 0 |
| | Surprised | 0 | 0 | 1 | 6 | 42 |

In order to further assess the proposed model, data was collected from subjects who were not previously included in the training dataset. This additional data was obtained from four individuals, comprising two males and two females using the same approach employed during the initial training data acquisition.

Upon gathering an additional 1,000 data points from these previously unseen subjects, the model was subsequently applied to this dataset for evaluation purposes.

The results demonstrated that the model maintained a high level of performance, achieving an accuracy rate of 86.38%. A detailed analysis of the class level accuracy for this evaluation can be found in Table 6, which presents the corresponding confusion matrix.

TABLE 6
Confusion Matrix on Data from Unseen Subject

| | | Ground Truth | | | | |
|---|---|---|---|---|---|---|
| | | Neutral | Smile | Kisses | Grimacing | Surprised |
| Prediction | Neutral | 196 | 0 | 4 | 0 | 3 |
| | Smile | 37 | 166 | 0 | 1 | 0 |
| | Kisses | 27 | 6 | 168 | 0 | 1 |
| | Grimacing | 4 | 35 | 2 | 162 | 0 |
| | Surprised | 6 | 0 | 1 | 11 | 183 |

The above embodiments are described by way of example only. Many variations are possible without departing from the scope of the disclosure as defined in the appended claims.

It would be appreciated that the system and method of the present disclosure provide an efficient and effective liveness detection method and system. Facial expressions are inherently more challenging to replicate or simulate as compared to simple head movements which are employed by some prior art approaches, thus providing a more secure and reliable means of liveness detection.

Advantageously, as described above, the computational resources and bandwidth required are minimised, the user experience is enhanced through the use of emoticons as prompts for the subsequent facial expressions whilst maintaining acceptable levels of accuracy. Optionally, the feature engineering/extraction and generation of the difference facial mesh representing the change in distance of the requisite facial landmarks may be performed on an edge device with limited computational resources and without consuming significant bandwidth by transmitting to and from a remote server of the raw images which have been captured.

Furthermore, as the feature extraction process does not require significant computational power (and potentially could be even performed within a web browser) this process is advantageously implemented in an embodiment via a web application. This avoids the need for operating system specific maintenance and customisation; as updates/interactions are managed by the software development kit of the edge device operating system.

Furthermore, using emoticons enhances user engagement with the process and potentially creates a more engaging and less monotonous liveness detection process. This enhanced approach not only maintains user interest but also encourages active participation, thereby contributing to a more effective and enjoyable authentication experience overall.

For clarity of explanation, in some instances the present technology may be presented as including individual functional blocks including functional blocks comprising devices, device components, steps or routines in a method embodied in software, or combinations of hardware and software.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer implemented method for processing images of the face of a subject, the method comprising:
acquiring a first plurality of images of at least a portion of the face of a subject;
generating an initial facial mesh representative of said at least portion of the face of the subject by analysing multiple images of the first plurality of images to extract corresponding facial landmarks from each image of the subject and corresponding edges extending therebetween;
issuing a plurality of prompts to the subject indicative of predetermined emotional states; acquiring a further plurality of images of at least a portion of the face of the subject after the issuance of each prompt;
generating a difference facial mesh for the subject after the issuance of each prompt by: extracting a plurality of edges characterising the distance between facial landmarks of the subject from an image selected from the further plurality of images of the face of the subject;
generating a further facial mesh from said plurality of edges and facial landmarks;
determining change of at least some predetermined edges of the further facial mesh relative to corresponding edges of the initial facial mesh.

2. The computer implemented method of claim 1 wherein said prompts comprise an emoticon indicative of different emotional states a subject may experience.

3. The computer implemented method of claim 2 wherein the emoticon is displayed to the subject on the same portable electronic device used for acquiring images of the subject.

4. The computer implemented method of claim 3 wherein the emoticon is indicative of an emotional state randomly selected from a group of predetermined emotional states.

5. The computer implemented method of claim 1 further comprising determining a scaling factor by calculating the distance between certain landmarks in the initial facial mesh for a subject and the distance between the same landmarks of the same subject in the further facial mesh; and
applying said scaling factor in the comparison of other edges of the difference facial mesh with the initial facial mesh of that subject.

6. The computer implemented method of claim 1 wherein the image selected for the determination of the difference facial mesh is selected randomly or according to predetermined criteria from the further plurality of acquired images.

7. The computer implemented method of claim 2 wherein the machine learning algorithm is a classifier trained to identify all of the emotional states of the subject in the sets of images of the subject.

8. The computer implemented method of claim 3 wherein the machine learning algorithm is a classifier trained to identify all of the emotional states of the subject in the sets of images of the subject.

9. The computer implemented method of claim 4 wherein the machine learning algorithm is a classifier trained to identify all of the emotional states of the subject in the sets of images of the subject.

10. The computer implemented method of claim 5 wherein the machine learning algorithm is a classifier trained to identify all of the emotional states of the subject in the sets of images of the subject.

11. A computer implemented method of verifying liveness of a subject depicted in a plurality of acquired images of the subject acquired at a first location comprising;
receiving over a network a plurality of difference facial mesh generated by a further processor at said first location following the issuance of a plurality of prompts indicative of an emotional state;
wherein each of said difference facial mesh is generated by:
acquiring a first plurality of image frames of the face of a subject;
generating an initial facial mesh representative of at least portion of the face of the subject of the face of the subject by analysing multiple images of the first plurality of images to extract corresponding facial landmarks from each image of the subject and corresponding edges extending therebetween; and
acquiring a further plurality of images of the face of the subject subsequent to communicating to the subject said prompt;
generating a further facial mesh derived from a plurality of edges characterising the distance between facial landmarks of the subject extracted from an image randomly selected from the second plurality of images of the face of the subject;
determining the change of at least some predetermined edges of the further facial mesh relative to corresponding edges of the initial facial mesh; and
evaluating by a model executing on one or more processors at a location remote from said first location; whether each of said received difference facial mesh corresponds to an expected emotional state for a subject following issuance of the prompt communicated to the subject;
wherein said model is trained using a machine learning algorithm.

12. The computer implemented method of claim 11 wherein said prompts comprise an emoticon indicative of different emotional states a subject may experience.

13. The computer implemented method of claim 12 wherein the emoticon is displayed to the subject on the same portable electronic device used for acquiring images of the subject.

14. The computer implemented method of claim 12 wherein the emoticon is indicative of an emotional state randomly selected from a group of predetermined emotional states.

15. The computer implemented method of claim 11 wherein the machine learning algorithm is a classifier trained to identify all of the emotional states of the subject in the sets of images of the subject.

16. A system for processing images of the face of a subject comprising:
one or more processors configured for
acquiring by an imaging apparatus in communication with the one or more processors a first plurality of images of at least a portion of the face of a subject;
generating by the one or more processors an initial facial mesh representative of said at least portion of the face of the subject by analysing multiple images of the first plurality of images to extract corresponding facial landmarks from each image of the subject and corresponding edges extending therebetween;
issuing by the one or more processors a plurality of prompts to the subject indicative of predetermined emotional states;
acquiring by the imaging apparatus a further plurality of images of at least a portion of the face of the subject after the issuance of each prompt;
generating by the one or more processors one or more difference facial mesh for the subject after the issuance of each prompt by:
extracting a plurality of edges characterising the distance between facial landmarks of the subject from an image selected from the further plurality of images of the face of the subject;
generating a further facial mesh from said plurality of edges and facial landmarks;
determining the change of at least some predetermined edges of the further facial mesh relative to corresponding edges of the initial facial mesh.

17. The system of processing images of a subject according to claim 16 wherein each step is performed by one or more processors of a portable electronic device having an image acquisition means for acquiring images of the face of the subject.

18. A system for verifying liveness of a subject depicted in a plurality of acquired images of the subject comprising:
receiving over a network a plurality of difference facial mesh generated by a further processor at a first location following the issuance of a plurality of prompts indicative of an emotional state;
wherein each difference facial mesh is generated at said first location by a processor of an electronic device performing the steps of:
acquiring a first plurality of image frames of the face of a subject
generating an initial facial mesh representative of at least portion of the face of the subject of the face of the subject by analysing multiple images of the first plurality of images to extract corresponding facial landmarks from each image of the subject and corresponding edges extending therebetween; and
acquiring a further plurality of images of the face of the subject subsequent to communicating to the subject said prompt;
generating a further facial mesh derived from a plurality of edges characterising the distance between facial landmarks of the subject extracted from an image randomly selected from the second plurality of images of the face of the subject;
determining the change of at least some predetermined edges of the further facial mesh relative to corresponding edges of the initial facial mesh; and
evaluating by a model executing on one or more processors at a location remote from said first location;
whether each of said received difference facial mesh corresponds to an expected emotional state for a subject following issuance of said prompt communicated to the subject; wherein said model is trained using a machine learning algorithm.

19. The system of verifying liveness of a subject depicted in a plurality of acquired images of the subject according to claim 18 wherein each step is performed by one or more processors of a portable electronic device having an image acquisition means for acquiring images of the face of the subject.

20. The system of determining liveness of a subject depicted in a plurality of acquired images of the subject according to claim 18 wherein the step of evaluating by the machine learning algorithm is performed after transmission of each difference facial mesh over a network to by a processor of one or more remotely located servers.
